(19) United States
(12) Patent Application Publication
(10) Pub. No.: US 2002/0128144 A1
(43) Pub. Date: Sep. 12, 2002

(54) Filler sand for a ladle tap hole valve

(75) Inventors: Manabu Tano, Tokyo (JP); Hideto Takasugi, Yokohama-shi (JP); Hirohisa Nakajima, Tokyo (JP); Akira Shirayama, Tokyo (JP); Manabu Arai, Tokyo (JP); Atsushi Tsunoda, Tokyo (JP); Masaki Komatani, Yokohama-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: NKK CORPORATION, Tokyo (JP)

(21) Appl. No.: 09/989,548

(22) Filed: Nov. 20, 2001

Related U.S. Application Data
(63) Continuation of application No. PCT/JP00/03345, filed on May 25, 2000.

(30) Foreign Application Priority Data
May 27, 1999 (JP) 11-147906

(51) Int. Cl. C04B 35/52; B32B 5/16

(52) U.S. Cl. 501/99; 428/402

(57) ABSTRACT

A filler sand for a ladle tap hole valve contains 45 to 55 mass % of zircon sand, 30 to 40 mass % of chromite sand and 10 to 20 mass % of silica sand and is blended externally with 0.05 to 5 mass % of carbon black calculated based on the total amount of the sands; or contains 30 to 90 mass % of chromite sand and 10 to 70 mass % of silica sand and is optionally blended externally with 0.05 to 5 mass % of carbon black, wherein 95 mass % or more of the chromite sand consists of particles having diameters falling within a range of 150 to 850 μm, 60 mass % or more of the chromite sand consists of particles having diameters falling within a range of 212 to 600 μm, 95 mass % or more of the silica sand consists of particles having diameters falling within a range of 300 to 1180 μm, and 90 mass % or more of the silica sand consists of particles having diameters falling within a range of 600 to 1180 μm.

### TECHNICAL FIELD

The present invention relates to a filler sand filled in a ladle tap hole valve, such as a sliding nozzle or a rotary nozzle, which is used in tapping molten steel from a steelmaking ladle etc.

### BACKGROUND ART

A ladle for receiving molten steel is used in a ladle refining process or continuous casting process carried out following a converter refining process, and a ladle tap hole valve (sliding nozzle or rotary nozzle) is arranged at the bottom of the ladle for tapping molten steel. In the ladle provided with such a ladle tap hole valve, to prevent molten steel from solidifying within a nozzle of the apparatus, the nozzle is charged with a refractory filler sand before receiving molten steel, and after molten steel is poured into the ladle, the nozzle is opened, whereby the filler sand falls freely, creating an opening by itself, or a free opening, through which the molten steel flows down.

Conventionally as such filler sand, silica sand (SiO₂: 90 to 99%) is generally used. The purity of SiO₂ is adjusted as needed depending on use to prevent sintering (Unexamined Japanese Patent Publication (KOKAI) No. 64-48662), or conversely, orthoclase (K₂O.Al₂O₃.6SiO₂) is added to cause sintering, thereby forming a viscous film in a region which comes into contact with molten steel to prevent penetration of the molten steel.

In the former case, however, although the filler sand can be prevented from sintering, penetration of molten steel cannot be effectively prevented, and thus no great improvement in the free opening ratio of the ladle can be expected. In the latter case, on the other hand, the filler sand can be used satisfactorily in ordinary operation, but in cases where molten steel needs to be processed at high temperature for a long time in ladle refining, etc. to produce high-grade steel, sintering of the filler sand itself progresses to such an extent that an unyielding film is formed, with the result that the free opening very often fails to be created. If no free opening is created, it is necessary that oxygen be blown from below with a long nozzle detached, to forcibly make an opening. However, contact of molten steel with air adversely affects the quality of the resulting steel, and thus the grade down of steel or scrap is produced, causing a great deal of damage.

To solve the problem, attempts have recently been made to admix the filler sand with flake graphite or earthy graphite, taking account of properties of graphite, that is, the property of inhibiting sintering and the property of being less wettable by molten steel. However, segregation is caused by a phenomenon occurring before graphite is put to use and is contained in a hopper, paper bag or container bag, such as by a difference in specific gravity or good sliding property of graphite, and thus expected results are not achieved yet in practice. Attempts have also been made to use pitch, but the use of pitch is not preferred because it has a 30 to 70% content of volatiles, gas is produced during use and segregation occurs.

There has also been proposed to add 0.05 to 5 mass % of carbon black to a filler sand such as silica sand, MgO clinker or zircon sand (Unexamined Japanese Patent Publication No. 4-84664). Carbon black has a high percentage of residue, has a small content of volatiles, and is excellent in preventing sintering and preventing penetration of molten steel, compared with the blending material such as flaky or earthy graphite, pitch, etc. Also, since carbon black has a large specific surface, it shows excellent dispersion when added to the filler sand and can prevent segregation. Further, carbon black is excellent in adhesion to silica sand. Filler sand admixed with carbon black is therefore regarded as a potential material having excellent properties required of the filler sand, such as the property of preventing sintering and penetration of molten steel.

However, although the filler sand disclosed in Unexamined Japanese Patent Publication No. 4-84664 is effective in some degree, the free opening ratio during a high tapping temperature and long lead time process involving ladle refining (VAD, VOD, etc.) is not of a satisfactory level, and thus there is a demand for a filler sand which ensures a high free opening ratio even under such severe conditions.

As a filler sand, chromite sand having a higher melting point than silica sand is also used. However, where chromite sand is used singly, it becomes sintered when molten steel is tapped, and the opening often fails to be created. Accordingly, chromite sand is seldom used singly and is used in combination with silica sand.

Even such a filler sand having chromite sand mixed with silica sand does not ensure a satisfactory free opening ratio in a high tapping temperature and long lead time process involving ladle refining (VAD, VOD, etc.). Also, the filler sand is liable to be sintered to the surface of a well block inside the ladle when a high tapping temperature and long lead time process is performed. Accordingly, the well block needs to be cleaned with oxygen with increased frequency, possibly shortening the life of the well block and lowering the yield because of residual steel in the ladle.

### DISCLOSURE OF THE INVENTION

An object of the present invention is to provide a filler sand for a ladle tap hole valve which filler sand ensures a high free opening ratio even when a high tapping temperature and long lead time process involving ladle refining (VAD, VOD, etc.) is performed.

According to a first aspect of the present invention, there is provided a filler sand for a ladle tap hole valve, characterized in that the filler sand contains 45 to 55 mass % of zircon sand, 30 to 40 mass % of chromite sand and 10 to 20 mass % of silica sand and is blended externally with 0.05 to 5 mass % of carbon black calculated based on a total amount of the sands.

The filler sand according to the first aspect of the invention is preferably blended with 0.05 to 1 mass % of carbon black calculated based on the total amount of the zircon sand, the chromite sand and the silica sand. Also, preferably, 95 mass % or more of the zircon sand consists of particles having particle diameters falling within a range of 100 to 300 μm, 95 mass % or more of the chromite sand consists of particles having particle diameters falling within a range of 150 to 850 μm, 60 mass % or more of the chromite sand consists of particles having particle diameters falling within a range of 200 to 425 μm, 95 mass % or more of the silica sand consists of particles having particle diameters falling within a range of 200 to 850 μm, and 60 mass % or more of the silica sand consists of particles having particle diameters falling within a range of 300 to 600 μm. Further, the silica sand preferably has a particle diameter coefficient of 1.4 or less. Preferably, moreover, the zircon sand contains substantially no particles having particle diameters smaller than 53 μm. Also, the chromite sand preferably contains substantially no particles having particle diameters smaller than 53 μm and substantially no particles having particle diameters exceeding 1180 μm. Still preferably, the silica sand contains substantially no particles having particle diameters smaller than 106 μm and substantially no particles having particle diameters exceeding 1180 μm. Further, the carbon black is preferably blended in such a manner that it is coated on the silica sand.

According to a second aspect of the present invention, there is provided a filler sand for a ladle tap hole valve, characterized in that the filler sand contains 30 to 90 mass % of chromite sand and 10 to 70 mass % of silica sand, 95 mass % or more of the chromite sand consists of particles having particle diameters falling within a range of 150 to 850 μm, 60 mass % or more of the chromite sand consists of particles having particle diameters falling within a range of 212 to 600 μm, 95 mass % or more of the silica sand consists of particles having particle diameters falling within a range of 300 to 1180 μm, and 90 mass % or more of the silica sand consists of particles having particle diameters falling within a range of 600 to 1180 μm.

According to a third aspect of the present invention, there is provided a filler sand for a ladle tap hole valve, characterized in that the filler sand contains 30 to 90 mass % of chromite sand and 10 to 70 mass % of silica sand and is blended externally with 0.05 to 5 mass % of carbon black calculated based on a total amount of the sands, 95 mass % or more of the chromite sand consists of particles having particle diameters falling within a range of 150 to 850 μm, 60 mass % or more of the chromite sand consists of particles having particle diameters falling within a range of 212 to 600 μm, 95 mass % or more of the silica sand consists of particles having particle diameters falling within a range of 300 to 1180 μm, and 90 mass % or more of the silica sand consists of particles having particle diameters falling within a range of 600 to 1180 μm.

In the filler sands according to the second and third aspects of the invention, the silica sand preferably has a particle diameter coefficient of 1.4 or less. Also, the chromite sand preferably contains substantially no particles having particle diameters 106 μm or less and substantially no particles having particle diameters exceeding 1180 μm. Still preferably, the silica sand contains substantially no particles having particle diameters smaller than 300 μm and substantially no particles having particle diameters exceeding 1700 μm. Further, the silica sand preferably has an Al₂O₃ content of 2 mass % or less, a total content of K₂O and Na₂O of 0.5 to 1.2 mass %, and an SiO₂ content of 96 to 98 mass %.

The filler sand according to the third aspect of the invention is preferably blended with 0.05 to 1 mass % of carbon black calculated based on the total amount of the chromite sand and the silica sand. Further, the carbon black is preferably blended in such a manner that it is coated on the silica sand. For molten steel whose tapping temperature is 1700° C. or more or whose molten steel holding time is 3 hours or more, the proportions of the chromite sand and the silica sand are preferably 70 to 90 mass % and 10 to 30 mass %, respectively. In the case of molten steel whose tapping temperature is less than 1700° C. and whose molten steel holding time is less than 3 hours, the proportions of the chromite sand and the silica sand are preferably 30 to 60 mass % and 40 to 70 mass %, respectively.

The inventors hereof made a study of filler sand for use in a ladle tap hole valve which filler sand can ensure a high free opening ratio even when a high tapping temperature and long lead time process involving long time ladle refining is performed. As a result of the study, they found that excellent properties could be obtained by blending a base material, which consisted of zircon sand, chromite sand and silica sand mixed in a certain ratio, with a small amount of carbon black. The inventors also found that excellent properties could be obtained by mixing chromite sand and silica sand having respective predetermined particle diameter distributions in a predetermined ratio, and that the properties could be furthered by blending such a base material of chromite and silica sands externally with a small amount of carbon black.

Namely, zircon sand, which is high refractoriness and low in expansibility, is blended with chromite sand and silica sand in an appropriate ratio so that the drawback of chromite sand, that is, liability to sintering when used singly despite its high melting temperature, and the drawback of silica sand, that is, low refractoriness, can both be compensated for. Further, since the sand mixture is blended with carbon black, the particles of the zircon, chromite and silica sands can be prevented from sintering and thus binding together, and also due to the penetration preventing property of carbon black, molten steel can be prevented from penetrating into the filler sand. Consequently, an extremely high free opening ratio can be obtained even when a process at a molten steel lead time of 300 minutes or more involving long time ladle refining is performed.

Also, by mixing silica sand and chromite sand having respective appropriate particle diameter distributions in an appropriate ratio, the drawback of silica sand, that is, low refractoriness, and the drawback of chromite sand, that is, liability to sintering when used singly despite its high melting temperature, can both be compensated for, whereby a high free opening ratio can be obtained even when a high tapping temperature and long lead time process is performed. Further, where the mixture of silica and chromite sands is blended with a suitable amount of carbon black, the particles of the chromite and silica sands can be prevented from sintering and thus binding together, and also due to the penetration preventing property of carbon black, penetration of molten steel into the filler sand can be prevented with higher reliability. A sufficiently high free opening ratio can therefore be obtained even when a higher tapping temperature and longer lead time process is performed. Specifically, in the case where no carbon black is added, the limits on the tapping temperature and the molten steel holding time are approximately 1700° C. and 3 hours, respectively. Where carbon black is added, on the other hand, a sufficiently high free opening ratio can be obtained even when a process is performed under severe conditions, such as at a tapping temperature of 1700° C. or more for a molten steel holding time of 3 hours or more.

The above advantageous effects cannot be achieved by the techniques disclosed in Unexamined Japanese Patent Publication No. 4-84664 mentioned above in which carbon black is merely added to silica sand, MgO clinker or zircon sand conventionally used as a filler sand. The advantages of the filler sand according to the first aspect of the present invention can be achieved by a combined effect provided by mixing zircon sand, chromite sand and silica sand in an appropriate ratio and by adding carbon black. Also, the advantages of the filler sand according to the second aspect of the present invention can be achieved by an appropriate mixing ratio of chromite and silica sands and their appropriate particle diameter distributions, and the advantages of the filler sand according to the third aspect of the invention can be achieved by a combined effect of the mixing ratio and the particle diameter distributions combined with the addition of carbon black.

The present invention was created based on the inventors' findings described above.

### BRIEF DESCRIPTION OF THE DRAWINGS

FIG. 1 is a sectional view showing a sliding nozzle as an example of a ladle tap hole valve to which a filler sand according to the present invention is applied;

FIG. 2 is a graph showing, by way of example, particle diameter distributions of zircon sand, chromite sand and silica sand used in an example of the present invention; and

FIG. 3 is a graph showing, by way of example, particle diameter distributions of chromite sand and silica sand used in other examples of the present invention.

### BEST MODE OF CARRYING OUT THE INVENTION

A filler sand for a ladle tap hole valve according to a first embodiment of the present invention contains 45 to 55 mass % of zircon sand, 30 to 40 mass % of chromite sand and 10 to 20 mass % of silica sand, and the filler sand is blended externally with 0.05 to 5 mass % of carbon black calculated based on the total amount of the sands.

In this embodiment, 45 to 55 mass % zircon sand, 30 to 40 mass % chromite sand and 10 to 20 mass % silica sand are blended in these ranges so as to compensate for both the drawback of chromite sand, that is, liability to sintering when used singly despite its high melting temperature, and the drawback of silica sand, that is, low refractoriness, and thereby increase the free opening ratio. Specifically, zircon sand and chromite sand have refractoriness of up to 2300° C. and 2030° C., respectively, considerably higher than that of silica sand of 1750° C., and by blending zircon sand and chromite sand with 10 to 20 mass % of silica sand, the problem with chromite sand, that is, liability to sintering, can be solved. Preferred ranges are 45 to 50 mass % for zircon sand, 35 to 40 mass % for chromite sand, and 15 to 20 mass % for silica sand.

The sand mixture is admixed externally with carbon black in the range of 0.05 to 5 mass % calculated based on the total amount of the zircon sand, the chromite sand and the silica sand, and adding carbon black in this range serves to prevent the particles of the zircon, chromite and silica sands from sintering and thus binding together. Also, due to the penetration preventing property of carbon black, molten steel can be prevented from penetrating into the filler sand.

If the content of carbon black is less than 0.05 mass %, a sufficient effect of preventing the sand particles from binding together is not obtained, and if 5 mass % is exceeded, the pickup amount of carbon into molten steel becomes too large. Thus, the content of carbon black is set to 0.05 to 5 mass %. In the case of making ultra low carbon steel, the pickup amount of carbon into molten steel must be reduced to the smallest possible value, and in such a case the content of carbon black is preferably restricted to 1 mass % or less.

Thus, zircon sand is mixed with chromite sand and silica sand in a predetermined ratio to compensate for the drawbacks of chromite sand and silica sand. Further, the sintering preventing effect and molten steel penetration preventing effect of carbon black are utilized in combination, whereby an extremely high free opening ratio can be obtained even when a process at the molten steel lead time of 300 minutes or more involving long time ladle refining.

If no carbon black is contained, the filler sand is liable to be sintered to the surface of a well block. Thus, the well block needs to be cleaned with oxygen with increased frequency, possibly shortening the life of the well block and causing reduction in the yield because of residual steel in the ladle. Such a problem can, however, be solved by blending carbon black.

Preferably, 95 mass % or more of the zircon sand consists of particles having particle diameters falling within a range of 100 to 300 μm, 95 mass % or more of the chromite sand consists of particles having particle diameters falling within a range of 150 to 850 μm, 60 mass % or more of the chromite sand consists of particles having particle diameters falling within a range of 200 to 425 μm, 95 mass % or more of the silica sand consists of particles having particle diameters falling within a range of 200 to 850 μm, and 60 mass % or more of the silica sand consists of particles having particle diameters falling within a range of 300 to 600 μm. By setting the particle diameter distributions in this manner, excessive production of sintered layer, bridging induced by thermal expansion, and penetration of slag or steel can be prevented more effectively. Namely, the degree of sintering and the molten steel penetration can be reduced to an even lower level, thereby greatly increasing the free opening ratio.

To enhance these advantageous effects, preferably, the zircon sand contains substantially no particles having particle diameters smaller than 53 μm, and the chromite sand contains substantially no particles having particle diameters smaller than 53 μm and/or substantially no particles having particle diameters exceeding 850 μm. Also, preferably, the silica sand contains substantially no particles having particle diameters smaller than 106 μm and/or substantially no particles having particle diameters exceeding 1180 μm. This makes it possible to obtain a high free opening ratio.

The particle size distribution is obtained based on the values measured in conformity with the particle size determination method (Z2602) for molding sand as provided by JIS. According to this method, sieves are stacked up in order of nominal size such that the coarsest sieve is located on top, and with a material put on the uppermost sieve, that is, on the coarsest sieve, the material is sieved using a screening machine such as a law-tap-type screening machine.

The silica sand used in the present invention preferably has a particle diameter coefficient of 1.4 or less, in order to improve the mixing uniformity. A more preferred range of the particle diameter coefficient is 1.3 to 1.

The particle diameter coefficient referred to herein represents a value calculated using a sand surface area measuring instrument (manufactured by George-Fisher Corporation). Specifically, the particle diameter coefficient represents a value obtained by dividing a surface area (specific surface area) per 1 g of actual sand by a theoretical specific surface. The theoretical specific surface denotes a specific surface based on the assumption that all sand particles are spherical in shape. Accordingly, rounder particles have a particle diameter coefficient closer to 1. Preferably, in view of the mixing uniformity, the zircon sand and the chromite sand also have a particle diameter coefficient of 1.4 or less.

The zircon sand and the chromite sand to be used in this embodiment are not particularly limited and may individually be obtained by subjecting naturally occurring sand as a raw material to drying, classifying, etc., or alternatively, naturally occurring sand may be directly used. Zircon sand generally contains about 65 mass % of ZrO₂. Typical zircon sand contains 66 mass % ZrO₂, 32 mass % SiO₂, about 0.5 mass % Al₂O₃, about 0.1 mass % Fe₂O₃, and about 0.3 mass % TiO₂, for example. Chromite sand, though its composition varies depending on the place of production, generally contains 30 mass % or more Cr₂O₃, preferably 30 to 60 mass % Cr₂O₃. For example, typical chromite sand contains 40 to 50 mass % of Cr₂O₃, 20 to 30 mass % of FeO, about 15 mass % of Al₂O₃, and about 10 mass % of MgO. Usually, the particle diameter coefficient of such chromite sand is 1.4 or less.

The silica sand to be used is also not particularly limited and may be obtained by subjecting naturally occurring silica sand as a raw material to drying, classifying, etc.; alternatively, naturally occurring silica sand may be directly used. The composition of silica sand also varies depending on the place of production, and it generally contains 90 mass % or more SiO₂. As such natural sand, Fremantle sand from Australia, royal sand from China, or domestic silica sand from the Tohoku region, for example, may be used. Silica sand may contain substances such as Al₂O₃, K₂O, Na₂O, etc. Preferably, however, the content of Al₂O₃ should be 2 mass % or less and the total content of K₂O and Na₂O should be approximately 0.5 to 1.2 mass %.

To make the quality each of the zircon sand, the chromite sand and the silica sand constant, sand which has been subjected to grinding may be used. Also, two or more types of ground or unground sands may be mixed.

For such grinding, either a dry process or a wet process, both conventionally known, may be adopted. The dry grinding process includes a process using a pneumatic scrubber such as a Sand reclaimer in which a sand material is blown up by a high-speed air flow to collide against a collision plate so that the sand particles may be ground by mutual collision and friction, and a process using a high-speed agitator such as an agitator mill in which sand is ground by friction. The wet grinding process, on the other hand, includes a process using a trough-type grinder in which blades are rotated so that sand particles in the trough may be ground by mutual friction.

Of these dry and wet grinding processes, the wet process is preferred because, where the wet process is adopted, sand particles smaller in size than a desired particle size can be removed at the same time as they are washed in water during the grinding process. Even in the case where the dry process is employed, a similar effect can be obtained by using a water washing device in combination.

The sand materials used in the filler sand of the present invention may be of any form insofar as the individual sands are blended in the aforementioned ratio. As for carbon black, however, carbon black having a suitable viscosity, more particularly, granular carbon black, should preferably be used. Such carbon black is preferably coated on the surface of the silica sand, and the silica sand thus coated with carbon black is uniformly mixed with the chromite sand and the zircon sand. This permits carbon black to be uniformly dispersed and also more effectively prevents sintering of the silica sand. The term “coat” means herein causing carbon black particles to adhere to the surfaces of the silica sand particles, and it does not necessarily mean forming a layer of carbon black. Carbon black may alternatively be coated on both the silica sand and the zircon sand or be coated on all of the silica sand, the chromite sand and the zircon sand.

A filler sand for a ladle tap hole valve according to a second embodiment of the present invention contains 30 to 90 mass % of chromite sand and 10 to 70 mass % of silica sand, wherein 95 mass % or more of the chromite sand consists of particles having particle diameters falling within a range of 150 to 850 μm, 60 mass % or more of the chromite sand consists of particles having particle diameters falling within a range of 212 to 600 μm, 95 mass % or more of the silica sand consists of particles having particle diameters falling within a range of 300 to 1180 μm, and 90 mass % or more of the silica sand consists of particles having particle diameters falling within a range of 600 to 1180 μm.

In this embodiment, 30 to 90 mass % chromite sand and 10 to 70 mass % silica sand are blended so as to compensate for both the drawback of silica sand, that is, low refractoriness, and the drawback of chromite sand, that is, liability to sintering when used singly despite its high melting temperature, and thereby increase the free opening ratio. Specifically, chromite sand has a refractoriness of up to 2030° C., considerably higher than that of silica sand of 1750° C., and by blending chromite sand with 10 to 70 mass % of silica sand, the problem with chromite sand, that is, liability to sintering, can be solved.

In this embodiment, the chromite sand has a particle diameter distribution such that 95 mass % or more of the chromite sand consists of particles having particle diameters falling within a range of 150 to 850 μm and that 60 mass % or more of the chromite sand consists of particles having particle diameters falling within a range of 212 to 600 μm. Also, the silica sand has a particle diameter distribution such that 95 mass % or more of the silica sand consists of particles having particle diameters falling within a range of 300 to 1180 μm and that 90 mass % or more of the silica sand consists of particles having particle diameters falling within a range of 600 to 1180 μm. By setting the particle diameter distributions of the chromite and silica sands in this manner, excessive production of sintered layer, bridging induced by thermal expansion, and penetration of slag or steel can be lessened, so that the free opening ratio can be greatly increased.

Thus, the chromite sand and the silica sand, each having such a particle diameter distribution as to increase the free opening ratio, are blended in the specified ratio, whereby the drawbacks of the two sands can be compensated for, permitting high tapping temperature, long lead time process.

To enhance the advantageous effects, preferably, the chromite sand contains substantially no particles having particle diameters smaller than 106 μm and/or substantially no particles having particle diameters exceeding 1180 μm. Also, preferably, the silica sand contains substantially no particles having particle diameters smaller than 300 μm and/or substantially no particles having particle diameters exceeding 1700 μm. This makes it possible to obtain a higher free opening ratio.

Like the first embodiment, the silica sand to be used preferably has a particle diameter coefficient of 1.4 or less, in order to improve the mixing uniformity. A more preferred range of the particle diameter coefficient is 1.3 to 1. In view of the mixing uniformity, the chromite sand also preferably has a particle diameter coefficient of 1.4 or less. Like the first embodiment, the particle diameter distribution is obtained based on the values measured in conformity with the particle size determination method (Z2602) for molding sand as provided by JIS. Also, the particle diameter coefficient referred to herein represents a value calculated using the sand surface area measuring instrument (manufactured by George-Fisher Corporation), as in the first embodiment.

The chromite sand and the silica sand to be used in this embodiment are not particularly limited and may individually be obtained by subjecting naturally occurring sand as a raw material to drying, classifying, etc., or alternatively, naturally occurring sand may be directly used, as in the first embodiment. To make the quality each of the chromite sand and the silica sand constant, sand which has been subjected to the aforementioned grinding process may be used. Also, two or more types of ground or unground sands may be mixed.

A filler sand for a ladle tap hole valve according to a third embodiment of the present invention contains 30 to 90 mass % of chromite sand and 10 to 70 mass % of silica sand and is blended externally with 0.05 to 5 mass % of carbon black calculated based on the total amount of the sands, wherein 95 mass % or more of the chromite sand consists of particles having particle diameters falling within a range of 150 to 850 μm, 60 mass % or more of the chromite sand consists of particles having particle diameters falling within a range of 212 to 600 μm, 95 mass % or more of the silica sand consists of particles having particle diameters falling within a range of 300 to 1180 μm, and 90 mass % or more of the silica sand consists of particles having particle diameters falling within a range of 600 to 1180 μm.

Namely, the chromite and silica sands used in this embodiment have the same particle diameter distributions and contents as those of the second embodiment, but are blended externally with 0.05 to 5 mass % of carbon black calculated based on the total amount of the sands.

The filler sand according to the second embodiment exhibits excellent properties for a high tapping temperature, long lead time process, but the conditions for using the filler sand are practically limited to a tapping temperature of not higher than 1700° C. and a molten steel holding time of not longer than 3 hours, because the limits on the tapping temperature and the molten steel holding time are approximately 1700° C. and 3 hours, respectively. By adding carbon black to the filler sand of the second embodiment, however, the sintering preventing effect and molten steel penetration preventing effect of carbon black can be combined with the effects achieved by the aforementioned contents and particle diameter distributions of the chromite and silica sands. Consequently, the resulting filler sand can ensure an extremely high free opening ratio even when a process at the tapping temperature of 1700° C. or more or the molten steel holding time of 3 hours or more is performed, not to speak when a process at the tapping temperature of less than 1700° C. and the molten steel holding time of less than 3 hours is performed.

The sand mixture is admixed externally with carbon black in the range of 0.05 to 5 mass % calculated based on the total amount of the chromite sand and the silica sand, and adding carbon black in this range serves to prevent the particles of the chromite and silica sands from sintering and thus binding together. Also, due to the molten steel penetration preventing property of carbon black, molten steel can be prevented with higher reliability from penetrating into the filler sand. Consequently, a high free opening ratio can be obtained even when a higher tapping temperature, longer lead time process is performed, or more specifically, a process at tapping temperature of 1700° C. or more and the molten steel holding time of 3 hours or more is performed. If the content of carbon black is less than 0.05 mass %, a sufficient effect of preventing the sand particles from binding together is not obtained, and if 5 mass % is exceeded, the pickup amount of carbon by molten steel becomes too large, with the result that the resulting steel fails to satisfy the composition standard. In the case of making ultra low carbon steel, the pickup amount of carbon into molten steel must be reduced to the smallest possible value, and in such a case the content of carbon black is preferably restricted to 1 mass % or less.

If no carbon black is contained, the filler sand is liable to be sintered to the surface of the well block. Thus, the well block needs to be cleaned with oxygen with increased frequency, possibly shortening the life of the well block and causing reduction in the yield because of residual steel in the ladle. Such a problem can, however, be solved by adding carbon black.

To enhance these advantageous effects, preferably, the chromite sand contains substantially no particles having particle diameters smaller than 106 μm and/or substantially no particles having particle diameters exceeding 1180 μm, and the silica sand contains substantially no particles having particle diameters smaller than 300 μm and/or substantially no particles having particle diameters exceeding 1700 μm. This makes it possible to obtain a higher free opening ratio.

In the case where carbon black is admixed, the resulting filler sand can be used for a process whose tapping temperature is 1700° C. or more or whose molten steel holding time is 3 hours or more, as mentioned above. To enhance safety, however, the composition of the filler sand should preferably varied depending upon the tapping temperature and the molten steel holding time. Specifically, for molten steel of which the tapping temperature is 1700° C. or more or the molten steel holding time is 3 hours or more, the contents of the chromite and silica sands are preferably set to 70 to 90 mass % and 10 to 30 mass %, respectively, and for molten steel of which the tapping temperature is less than 1700° C. and the molten steel holding time is less than 3 hours, the contents of the chromite and silica sands are preferably set to 30 to 60 mass % and 40 to 70 mass %, respectively.

Also, like the first and second embodiments, the silica sand to be used preferably has a particle diameter coefficient of 1.4 or less, in order to improve the mixing uniformity. A more preferred range of the particle diameter coefficient is 1.3 to 1. In view of the mixing uniformity, the chromite sand also preferably has a particle diameter coefficient of 1.4 or less. Like the first and second embodiments, the particle size distribution is obtained based on the values measured in conformity with the particle size determination method (Z2602) for molding sand as provided by JIS. Also, the particle diameter coefficient represents a value calculated using the sand surface area measuring instrument (manufactured by George-Fisher Corporation), as in the first and second embodiments.

The chromite sand and the silica sand to be used in this embodiment are not particularly limited and may individually be obtained by subjecting naturally occurring sand as a raw material to drying, classifying, etc., or alternatively, naturally occurring sand may be directly used, as in the first and second embodiments. To make the quality each of the chromite sand and the silica sand constant, sand which has been subjected to the aforementioned grinding process may be used. Also, two or more types of ground or unground sands may be mixed.

The sand materials used in the filler sand of the present invention may be of any form insofar as the individual sands are blended in the aforementioned ratio. As for carbon black, however, carbon black having a suitable viscosity, more particularly, granular carbon black, should preferably be used, as in the first embodiment. Such carbon black is coated on the surface of the silica sand, and the silica sand thus coated with carbon black is uniformly mixed with the chromite sand. This permits carbon black to be uniformly dispersed and also more effectively prevents sintering of the silica sand. The term “coat” means herein causing carbon black particles to adhere to the surfaces of the silica sand particles, and it does not necessarily mean forming a layer of carbon black. Carbon black may be coated on the silica sand only or be coated on both the silica sand and the chromite sand.

The ladle tap hole valve to which the filler sand of the present invention is applied includes a sliding nozzle and a rotary nozzle, the shape of which is not particularly limited.

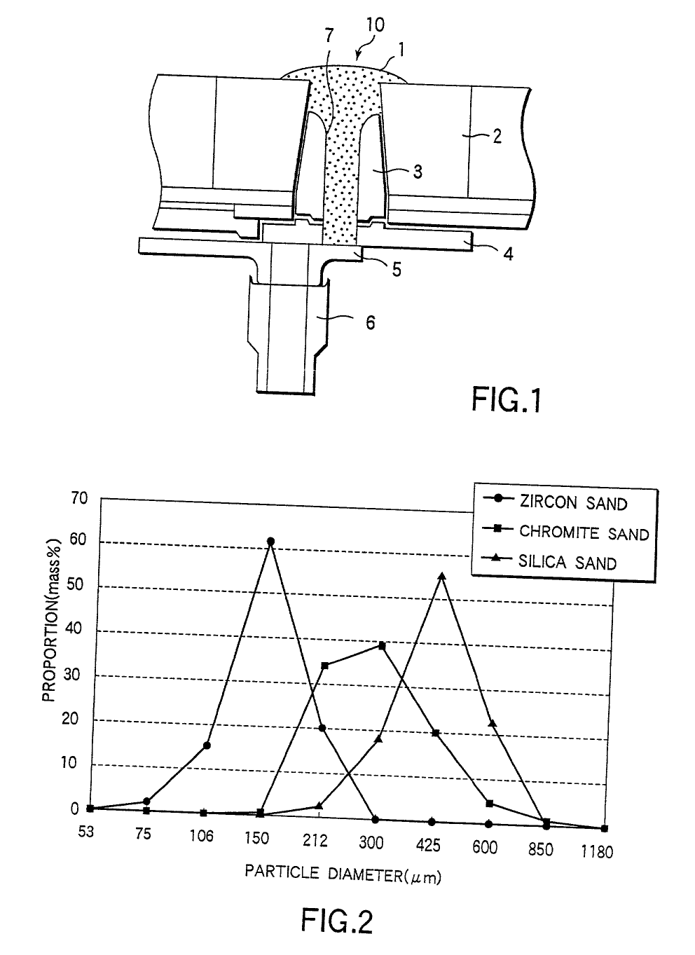

FIG. 1 shows a structure of a sliding nozzle, as an example of the ladle tap hole valve to which the filler sand of the present invention is applied. A sliding nozzle 10 comprises an upper nozzle 3, a well block 2 laterally supporting the upper nozzle, a fixed plate 4 supporting the upper nozzle 3 from below, a slide plate 5 slidable relative to the fixed plate 4, and a lower nozzle 6 attached to the bottom of the slide plate 5. A filler sand 1 according to the present invention is filled in a nozzle hole 7 defined by the upper nozzle 3. With the sliding nozzle 10 closed as illustrated in the figure, molten steel is poured into the ladle. After the molten steel is poured, the slide plate 5 is moved, whereby the sliding nozzle 10 opens. Consequently, the filler sand 1 falls and the nozzle hole 7 opens by itself. A rotary nozzle has a basic structure similar to that of the sliding nozzle and differs therefrom only in that the slide plate is rotatable.

### EXAMPLES

Specific examples according to the present invention will be now described.

### Examples 1

In the following, examples corresponding to the first embodiment of the present invention will be explained.

Each of filler sands obtained by blending zircon sand, chromite sand, silica sand and carbon black in respective ratios shown in Table 1 was filled in the nozzle hole of 75 mmφ in nozzle diameter of a ladle tap hole valve arranged at the bottom of a 250-ton ladle, and a free opening ratio was measured for 1000 charges. In Test 1, a process at a molten steel lead time of 200 minutes or less was performed for almost all charges. In Test 2, a process under a severer condition of at a molten steel lead time of 300 minutes or more involving long time ladle refining was performed for 10% charges of all the charges. The free opening ratios obtained in these tests are also shown in Table 1. Symbols in the columns “Particle Diameter Distribution of Zircon Sand”, “Particle Diameter Distribution of Chromite Sand” and “Particle Diameter Distribution of Silica Sand” of Table 1 represent respective particle diameter distributions shown in Tables 2 to 4. For the carbon black, granular carbon black having a particle diameter of 150 to 1000 μm was used. The zircon sand, the chromite sand and the silica sand had a particle diameter coefficient of 1.3 or less.

TABLE 1

| | | | | | Particle | Particle | Particle | | | |
|---|---|---|---|---|---|---|---|---|---|---|
| | Blend Ratio (mass %) | | | Carbon | Diameter | Diameter | Diameter | Free opening Ratio | | |
| Sample | Zircon | Chromite | Silica | Black | Distribution of | Distribution of | Distribution of | (%) | | |
| No. | Sand | Sand | Sand | (mass %) | Zircon Sand | Chromite Sand | Silica Sand | Test 1 | Test 2 | Remarks |
| 1 | 50 | 35 | 15 | 0 | Z | A | a | 100 | 99.8 | Comparative Example |
| 2 | 50 | 35 | 15 | 0.1 | Z | A | a | 100 | 100 | Example |
| 3 | 50 | 35 | 15 | 0.5 | Z | A | a | 100 | 100 | Example |
| 4 | 50 | 35 | 15 | 3 | Z | A | a | 100 | 100 | Example |
| 5 | 50 | 35 | 15 | 6 | Z | A | a | 100 | 99.8 | Comparative Example |
| 6 | 50 | 35 | 15 | 0.1 | Z | B | b | 99.6 | 99.4 | Example |
| 7 | 50 | 35 | 15 | 0.5 | Z | B | b | 99.6 | 99.4 | Example |
| 8 | 50 | 35 | 15 | 3 | Z | B | b | 99.6 | 99.4 | Example |
| 9 | 50 | 35 | 15 | 0.1 | Z | A | c | 99.4 | 99.2 | Example |
| 10 | 50 | 35 | 15 | 0.5 | Z | A | c | 99.4 | 99.2 | Example |
| 11 | 50 | 35 | 15 | 3 | Z | A | c | 99.4 | 99.2 | Example |
| 12 | 50 | 35 | 15 | 0.1 | Z | C | a | 99.4 | 99.2 | Example |
| 13 | 50 | 35 | 15 | 0.5 | Z | C | a | 99.4 | 99.2 | Example |
| 14 | 50 | 35 | 15 | 3 | Z | C | a | 99.4 | 99.2 | Example |
| 15 | 35 | 50 | 15 | 0.1 | Z | A | a | 99.0 | 98.0 | Comparative Example |
| 16 | 35 | 50 | 15 | 0.5 | Z | A | a | 99.0 | 98.0 | Comparative Example |
| 17 | 35 | 50 | 15 | 3 | Z | A | a | 99.0 | 98.0 | Comparative Example |
| 18 | 15 | 35 | 50 | 0.1 | Z | A | a | 98.0 | 97.0 | Comparative Example |
| 19 | 15 | 35 | 50 | 0.5 | Z | A | a | 98.0 | 97.0 | Comparative Example |
| 20 | 15 | 35 | 50 | 3 | Z | A | a | 98.0 | 97.0 | Comparative Example |
| 21 | 50 | 0 | 50 | 0.1 | Z | — | a | 97.0 | 96.0 | Comparative Example |
| 22 | 50 | 0 | 50 | 0.5 | Z | — | a | 97.0 | 96.0 | Comparative Example |
| 23 | 50 | 0 | 50 | 3 | Z | — | a | 97.0 | 96.0 | Comparative Example |
| 24 | 50 | 50 | 0 | 0.1 | Z | A | — | 98.0 | 97.0 | Comparative Example |
| 25 | 50 | 50 | 0 | 0.5 | Z | A | — | 98.0 | 97.0 | Comparative Example |
| 26 | 50 | 50 | 0 | 3 | Z | A | — | 98.0 | 97.0 | Comparative Example |

TABLE 2

| Sample | Particle Diameter Distribution of Zircon Sand (mass %) | | | | | | | | | | |
|---|---|---|---|---|---|---|---|---|---|---|---|
| No. | >1180 μm | >850 μm | >600 μm | >425 μm | >300 μm | >212 μm | >150 μm | >106 μm | >75 μm | >53 μm | ≦53 μm |
| Z | — | — | — | — | 0.1 | 20.3 | 61.9 | 15.4 | 2.2 | 0.1 | — |

TABLE 3

| Sample | Particle Diameter Distribution of Chromite Sand (mass %) | | | | | | | | | | |
|---|---|---|---|---|---|---|---|---|---|---|---|
| No. | >1180 μm | >850 μm | >600 μm | >425 μm | >300 μm | >212 μm | >150 μm | >106 μm | >75 μm | >53 μm | ≦53 μm |
| A | — | 0.9 | 4.5 | 20.2 | 39.2 | 34.5 | 0.7 | — | — | — | — |
| B | — | 1.5 | 0.3 | 2.6 | 14.0 | 38.2 | 34.6 | 7.8 | 0.7 | 0.3 | — |
| C | — | 3.0 | 5.2 | 17.5 | 28.5 | 30.2 | 12.4 | 3.0 | 0.1 | 0.1 | — |

TABLE 4

| Sample | Particle Diameter Distribution of Silica Sand (mass %) | | | | | | | | | | |
|---|---|---|---|---|---|---|---|---|---|---|---|
| No. | >1180 μm | >850 μm | >600 μm | >425 μm | >300 μm | >212 μm | >150 μm | >106 μm | >75 μm | >53 μm | ≦53 μm |
| a | — | 0.5 | 22.7 | 55.8 | 18.1 | 2.5 | 0.4 | — | — | — | — |
| b | — | 1.8 | 30.5 | 44.5 | 19.6 | 3.2 | 0.5 | 0.1 | 0.1 | — | — |
| c | — | 3.8 | 28.5 | 40.4 | 21.7 | 3.2 | 2.0 | 0.1 | 0.1 | — | — |

Among the examples satisfying the ranges of the present invention, Sample Nos. 2 to 4 and 6 to 14 showed a high free opening ratio of 99.4% or more in Test 1, and showed a high free opening ratio of 99.2% or more in Test 2. Especially, Sample Nos. 2 to 4 and 6 to 8 of which the chromite sand and the silica sand had particle diameter distributions falling within respective preferred ranges showed excellent results, and among these, Sample Nos. 2 to 4 containing smaller amounts of coarse particles and fine particles showed a 100% free opening ratio in both tests. In the samples containing 0.5 mass % carbon black, the pickup amount of carbon into molten steel was nearly zero, proving that these fillers could be used in making ultra low carbon steel. The particle diameter distributions of the zircon sand, the chromite sand and the silica sand used in Sample Nos. 2 to 4 are shown in FIG. 2.

By contrast, Sample No. 1, which contained chromite sand and silica sand in a ratio falling within the range of the present invention but no carbon black and of which the chromite sand and the silica sand had particle diameter distributions falling within the respective preferred ranges, showed an excellent free opening ratio in Test 1 but a somewhat low free opening ratio of 99.8% in Test 2, compared with the 100% free opening ratio. Also, this filler sand was sintered to the surface of the well block with high frequency and the frequency of cleaning the well block with oxygen was high, with the result that the life of the well block greatly shortened. Sample No. 5 having a large carbon black content showed an excellent free opening ratio but was found to be unsuitable for actual use because of a large pickup amount of carbon by molten steel.

Sample Nos. 15 to 17 containing chromite sand and silica sand in ratios outside the range of the present invention, Sample Nos. 18 to 20 containing zircon sand, chromite sand and silica sand in ratios outside the range of the present invention, and Sample Nos. 21 to 26 containing either zircon and chromite sands or zircon and silica sands failed to show a good free opening ratio in Tests 1 and 2, though carbon black was coated.

From these results, it was confirmed that by blending zircon sand, chromite sand, silica sand and carbon black in an appropriate ratio, a high free opening ratio could be obtained even when a process at the molten steel lead time of 300 minutes or more involving long time ladle refining is performed.

As described above, the filler sand of the present invention is obtained by blending zircon sand, chromite sand, silica sand and carbon black in an appropriate ratio, whereby a high free opening ratio can be ensured even when a process is performed under severe conditions, such as a process at the molten steel lead time of 300 minutes or more involving long time ladle refining.

### Examples 2

Examples corresponding to the second embodiment of the present invention will be now explained.

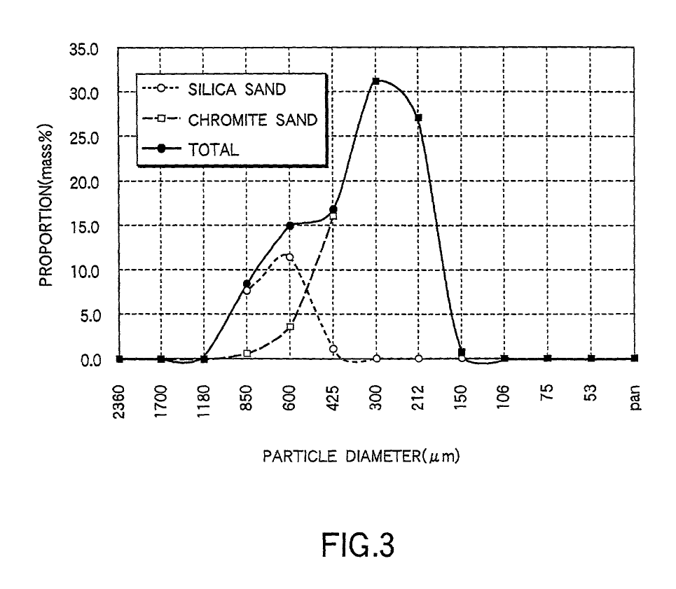

Each of filler sands obtained by blending chromite sand and silica sand in respective ratios shown in Table 5 was filled in the nozzle hole of 75 mmφ in nozzle diameter of a ladle tap hole valve arranged at the bottom of a 250-ton ladle, and a free opening ratio was measured for 1000 charges. In Test 3, a process at the tapping temperature of less than 1700° C. and the molten steel holding time of less than 3 hours was performed for all charges. The free opening ratios obtained in these tests are also shown in Table 5. Symbols in the columns “Particle Diameter Distribution of Chromite Sand” and “Particle Diameter Distribution of Silica Sand” of Table 5 represent respective particle diameter distributions shown in Tables 6 and 7. For the carbon black, granular carbon black having a particle diameter of 150 to 1000 μm was used. The chromite sand and the silica sand had a particle diameter coefficient of 1.3 or less. Also, the particle diameter distributions of the chromite and silica sands used in Sample No. 27 are shown in FIG. 3.

TABLE 5

| | | | Particle Diameter | Particle Diameter | Free Opening | |
|---|---|---|---|---|---|---|
| | Blend Ratio (mass %) | | Distribution of | Distribution of Silica | Ratio (%) | |
| Sample No. | Chromite Sand | Silica Sand | Chromite Sand | Sand | Test 3 | Remarks |
| 27 | 80 | 20 | D | d | 100 | Example |
| 28 | 80 | 20 | E | e | 98.5 | Comparative Example |
| 29 | 80 | 20 | F | d | 98.5 | Comparative Example |
| 30 | 80 | 20 | D | e | 98.5 | Comparative Example |
| 31 | 60 | 40 | D | d | 100 | Example |
| 32 | 60 | 40 | D | f | 98.0 | Comparative Example |
| 33 | 60 | 40 | E | e | 98.0 | Comparative Example |
| 34 | 50 | 50 | D | d | 100 | Example |
| 35 | 50 | 50 | E | e | 98.0 | Comparative Example |
| 36 | 30 | 70 | D | d | 100 | Example |
| 37 | 30 | 70 | F | d | 97.5 | Comparative Example |

TABLE 6

| Distri- | Particle Diameter Distribution of Chromite Sand (mass %) | | | | | | | | | | | |
|---|---|---|---|---|---|---|---|---|---|---|---|---|
| bution | >1700 μm | >1180 μm | >850 μm | >600 μm | >425 μm | >300 μm | >212 μm | >150 μm | >106 μm | >75 μm | >53 μm | ≦53 μm |
| D | — | — | 0.9 | 4.5 | 20.2 | 39.2 | 34.5 | 0.7 | — | — | — | — |
| E | 1.0 | 1.2 | 1.5 | 1.8 | 2.6 | 10.3 | 38.2 | 34.6 | 7.8 | 0.7 | 0.2 | 0.1 |
| F | 2.0 | 3.0 | 4.0 | 5.2 | 17.5 | 22.5 | 30.2 | 12.4 | 3.0 | 0.1 | 0.1 | — |

TABLE 7

| Distri- | Particle Diameter Distribution of Silica Sand (mass %) | | | | | | | | | | | |
|---|---|---|---|---|---|---|---|---|---|---|---|---|
| bution | >1700 μm | >1180 μm | >850 μm | >600 μm | >425 μm | >300 μm | >212 μm | >150 μm | >106 μm | >75 μm | >53 μm | ≦53 μm |
| d | — | 0.5 | 38.4 | 56.9 | 4.1 | 0.1 | — | — | — | — | — | — |
| e | 1.8 | 2.3 | 4.5 | 30.5 | 37.4 | 19.6 | 3.2 | 0.5 | 0.1 | 0.1 | — | — |
| f | 3.8 | 5.0 | 6.0 | 17.7 | 40.4 | 21.7 | 3.2 | 2.0 | 0.1 | 0.1 | — | — |

As a result, Sample Nos. 27, 31, 34 and 36 corresponding to examples satisfying the ranges of the present invention all showed a 100% free opening ratio. By contrast, Sample Nos. 28 to 30, 32, 33, 35 and 37 of which either the mixing ratio or particle diameter distributions of the sands were outside the ranges of the present invention showed a poor free opening ratio.

From these results, it was confirmed that with the filler sand of the present invention, an extremely high free opening ratio could be ensured under conditions of a tapping temperature of less than 1700° C. and a molten steel holding time of less than 3 hours.

### Examples 3

Examples corresponding to the third embodiment of the present invention will be now explained.

Each of filler sands obtained by blending chromite sand, silica sand and carbon black in respective ratios shown in Table 8 was filled in the nozzle hole of 75 mmφ in nozzle diameter of a ladle tap hole valve arranged at the bottom of a 250-ton ladle, and a free opening ratio was measured for 1000 charges. In Test 3, a process at the tapping temperature of less than 1700° C. and the molten steel residence time of less than 3 hours was performed for all charges. In Test 4, a process under severe conditions at a tapping temperature of 1700° C. or more or a molten steel holding time of 3 hours or more involving long time ladle refining was performed for 100% charges of all the charges. The free opening ratios obtained in these tests are also shown in Table 8. Symbols in the columns “Particle Diameter Distribution of Chromite Sand” and “Particle Diameter Distribution of Silica Sand” of Table 8 represent respective particle diameter distributions shown in Tables 6 and 7 given above. For the carbon black, granular carbon black having a particle diameter of 150 to 1000 μm was used. The chromite sand and the silica sand had a particle diameter coefficient of 1.3 or less. The particle diameter distributions of the chromite and silica sands used in Sample Nos. 38 to 41 were identical with those of the chromite and silica sands used in Sample No. 27 of Examples 2 and therefore, are shown in FIG. 3.

TABLE 8

| | | | Carbon | Particle Diameter | Particle Diameter | Free opening Ratio | | |
|---|---|---|---|---|---|---|---|---|
| Sample | Blend Ratio (mass %) | | Black | Distribution of | Distribution of | (%) | | |
| No. | Chromite Sand | Silica Sand | (mass %) | Chromite Sand | Silica Sand | Test 3 | Test 4 | Remarks |
| 38 | 80 | 20 | 0.1 | D | d | 100 | 100 | Example |
| 39 | 80 | 20 | 0.5 | D | d | 100 | 100 | Example |
| 40 | 80 | 20 | 3 | D | d | 100 | 100 | Example |
| 41 | 80 | 20 | 6 | D | d | 100 | 99.8 | Comparative Example |
| 42 | 80 | 20 | 0.1 | E | e | 98.5 | 97.5 | Comparative Example |
| 43 | 80 | 20 | 0.5 | E | e | 98.5 | 97.5 | Comparative Example |
| 44 | 80 | 20 | 3 | E | e | 98.5 | 97.5 | Comparative Example |
| 45 | 80 | 20 | 0.1 | D | f | 98.5 | 97.5 | Comparative Example |
| 46 | 80 | 20 | 0.5 | D | f | 98.5 | 97.5 | Comparative Example |
| 47 | 80 | 20 | 3 | D | f | 98.5 | 97.5 | Comparative Example |
| 48 | 80 | 20 | 0.1 | F | d | 98.5 | 97.5 | Comparative Example |
| 49 | 80 | 20 | 0.5 | F | d | 98.5 | 97.5 | Comparative Example |
| 50 | 80 | 20 | 3 | F | d | 98.5 | 97.5 | Comparative Example |
| 51 | 60 | 40 | 0.1 | D | d | 100 | 98.0 | Example |
| 52 | 60 | 40 | 0.5 | D | d | 100 | 98.0 | Example |
| 53 | 60 | 40 | 3 | D | d | 100 | 98.0 | Example |
| 54 | 50 | 50 | 0.1 | D | d | 100 | 98.0 | Example |
| 55 | 50 | 50 | 0.5 | D | d | 100 | 98.0 | Example |
| 56 | 50 | 50 | 3 | D | d | 100 | 98.0 | Example |
| 57 | 30 | 70 | 0.1 | D | d | 100 | 98.0 | Example |
| 58 | 30 | 70 | 0.5 | D | d | 100 | 98.0 | Example |
| 59 | 30 | 70 | 3 | D | d | 100 | 98.0 | Example |
| 60 | 0 | 100 | 0.1 | — | d | 98.0 | 97.0 | Comparative Example |
| 61 | 0 | 100 | 0.5 | — | d | 98.0 | 97.0 | Comparative Example |
| 62 | 0 | 100 | 3 | — | d | 98.0 | 97.0 | Comparative Example |
| 63 | 100 | 0 | 0.1 | D | — | 98.0 | 97.0 | Comparative Example |
| 64 | 100 | 0 | 0.5 | D | — | 98.0 | 97.0 | Comparative Example |
| 65 | 100 | 0 | 3 | D | — | 98.0 | 97.0 | Comparative Example |

As a result, Sample Nos. 38 to 40 and 51 to 59 corresponding to examples satisfying the ranges of the present invention showed a 100% free opening ratio in Test 3 which was conducted under the conditions that the tapping temperature and the molten steel holding time were less than 1700° C. and 3 hours, respectively, and also showed an extremely high free opening ratio in Test 4 which was conducted under severer conditions that the tapping temperature was 1700° C. or more or that the molten steel holding time was 3 hours or more. Among these examples, Sample Nos. 38 to 40 having an optimized ratio of the chromite and silica sands and admixed with carbon black showed a 100% free opening ratio in Test 4, proving remarkably good properties. Also, in Sample No. 38 containing 0.1 mass % carbon black and Sample No. 39 containing 0.5 mass % carbon black, the pickup amount of carbon into molten steel was nearly zero, proving that these filler sands can be used in making ultra low carbon steel.

By contrast, Sample Nos. 41 to 50 and 60 to 65, which did not satisfy some of the ranges of the present invention, failed to show good properties. Specifically, Sample No. 41 having a carbon black content outside the range of the present invention was found to be unsuitable for actual use because of a large pickup amount of carbon into molten steel. Also, Sample Nos. 42 to 50 of which at least one of the chromite and silica sands had a particle diameter distribution outside the range of the present invention, and Sample Nos. 60 to 65 containing either the chromite or silica sand alone with carbon black added did not show a high free opening ratio, though carbon black was added.

From these results, it was confirmed that with the filler sand of the present invention, an extremely high free opening ratio could be obtained even under severe conditions that the tapping temperature was 1700° C. or more or that the molten steel holding time was 3 hours or more, not to speak of the conditions that the tapping temperature and the molten steel holding time were less than 1700° C. and 3 hours, respectively.

1. A filler sand for a ladle tap hole valve, characterized in that said filler sand contains 45 to 55 mass % of zircon sand, 30 to 40 mass % of chromite sand and 10 to 20 mass % of silica sand, and is blended externally with 0.05 to 5 mass % of carbon black calculated based on a total amount of the zircon sand, the chromite sand and the silica sand.

2. The filler sand according to claim 1, wherein said filler sand is blended with 0.05 to 1 mass % of carbon black calculated based on the total amount of the zircon sand, the chromite sand and the silica sand.

3. The filler sand according to claim 1, wherein 95 mass % or more of the zircon sand consists of particles having particle diameters falling within a range of 100 to 300 μm, 95 mass % or more of the chromite sand consists of particles having particle diameters falling within a range of 150 to 850 μm, 60 mass % or more of the chromite sand consists of particles having particle diameters falling within a range of 200 to 425 μm, 95 mass % or more of the silica sand consists of particles having particle diameters falling within a range of 200 to 850 μm, and 60 mass % or more of the silica sand consists of particles having particle diameters falling within a range of 300 to 600 μm.

4. The filler sand according to claim 1, wherein the silica sand has a particle diameter coefficient of 1.4 or less.

5. The filler sand according to claim 1, wherein the zircon sand contains substantially no particles having particle diameters smaller than 53 μm.

6. The filler sand according to claim 1, wherein the chromite sand contains substantially no particles having particle diameters smaller than 53 μm.

7. The filler sand according to claim 1, wherein the chromite sand contains substantially no particles having particle diameters exceeding 1180 μm.

8. The filler sand according to claim 1, wherein the silica sand contains substantially no particles having particle diameters smaller than 106 μm.

9. The filler sand according to claim 1, wherein the silica sand contains substantially no particles having particle diameters exceeding 1180 μm.

10. The filler sand according to claim 1, wherein the carbon black is blended in a manner such that the carbon black is coated on the silica sand.

11. A filler sand for a ladle tap hole valve, characterized in that said filler sand contains 30 to 90 mass % of chromite sand and 10 to 70 mass % of silica sand, 95 mass % or more of the chromite sand consists of particles having particle diameters falling within a range of 150 to 850 μm, 60 mass % or more of the chromite sand consists of particles having particle diameters falling within a range of 212 to 600 μm, 95 mass % or more of the silica sand consists of particles having particle diameters falling within a range of 300 to 1180 μm, and 90 mass % or more of the silica sand consists of particles having particle diameters falling within a range of 600 to 1180 μm.

12. The filler sand according to claim 11, wherein the silica sand has a particle diameter coefficient of 1.4 or less.

13. The filler sand according to claim 11, wherein the chromite sand contains substantially no particles having particle diameters 106 μm or less.

14. The filler sand according to claim 11, wherein the chromite sand contains substantially no particles having particle diameters exceeding 1180 μm.

15. The filler sand according to claim 11, wherein the silica sand contains substantially no particles having particle diameters smaller than 300 μm.

16. The filler sand according to claim 11, wherein the silica sand contains substantially no particles having particle diameters exceeding 1700 μm.

17. The filler sand according to claim 11, wherein the silica sand has an Al₂O₃ content of 2 mass % or less, and a total content of K₂O and Na₂O of 0.5 to 1.2 mass %.

18. The filler sand according to claim 11, wherein the silica sand has an SiO₂ content of 96 to 98 mass %.

19. A filler sand for a ladle tap hole valve, characterized in that said filler sand contains 30 to 90 mass % of chromite sand and 10 to 70 mass % of silica sand and is blended externally with 0.05 to 5 mass % of carbon black calculated based on a total amount of the chromite sand and the silica sand, 95 mass % or more of the chromite sand consists of particles having particle diameters falling within a range of 150 to 850 μm, 60 mass % or more of the chromite sand consists of particles having particle diameters falling within a range of 212 to 600 μm, 95 mass % or more of the silica sand consists of particles having particle diameters falling within a range of 300 to 1180 μm, and 90 mass % or more of the silica sand consists of particles having particle diameters falling within a range of 600 to 1180 μm.

20. The filler sand according to claim 19, wherein said filler sand is blended with 0.05 to 1 mass % of carbon black calculated based on the total amount of the chromite sand and the silica sand.

21. The filler sand according to claim 19, wherein the silica sand has a particle diameter coefficient of 1.4 or less.

22. The filler sand according to claim 19, wherein the chromite sand contains substantially no particles having particle diameters 106 μm or less.

23. The filler sand according to claim 19, wherein the chromite sand contains substantially no particles having particle diameters exceeding 1180 μm.

24. The filler sand according to claim 19, wherein the silica sand contains substantially no particles having particle diameters smaller than 300 μm.

25. The filler sand according to claim 19, wherein the silica sand contains substantially no particles having particle diameters exceeding 1700 μm.

26. The filler sand according to claim 19, wherein the carbon black is coated on the silica sand.

27. The filler sand according to claim 19, wherein the silica sand has an Al₂O₃ content of 2 mass % or less, and a total content of K₂O and Na₂O of 0.5 to 1.2 mass %.

28. The filler sand according to claim 19, wherein the silica sand has an SiO₂ content of 96 to 98 mass %.

29. The filler sand according to claim 19, wherein, for molten steel whose tapping temperature is 1700° C. or more or whose molten steel holding time is 3 hours or more, the proportions of the chromite sand and the silica sand are 70 to 90 mass % and 10 to 30 mass %, respectively.

30. The filler sand according to claim 19, wherein, for molten steel whose tapping temperature is less than 1700° C. and whose molten steel holding time is less than 3 hours, the proportions of the chromite sand and the silica sand are 30 to 60 mass % and 40 to 70 mass %, respectively.
